(19) United States
(12) Patent Application Publication
(10) Pub. No.: US 2017/0073553 A1
(43) Pub. Date: Mar. 16, 2017

(54) Graphene glue, its composition and using method

(71) Applicants: Kuo-Hsin CHANG, Manchester (GB); Jia-Cing CHEN, Tainan (TW); Ching-Yu LU, Manchester (GB)

(72) Inventors: Kuo-Hsin CHANG, Manchester (GB); Jia-Cing CHEN, Tainan (TW); Ching-Yu LU, Manchester (GB)

(21) Appl. No.: 14/854,062

(22) Filed: Sep. 15, 2015

(51) Int. Cl. C09J 9/02; C09K 5/14; B05D 3/00; C09J 1/00

(52) U.S. Cl. CPC C09J 9/02; C09J 1/00; C09K 5/14; B05D 3/007

(57) ABSTRACT

Graphene glue contains graphene which is directly used as adhesives to bind different components/materials together. Materials such as metal powders, carbon powders, metal oxides, polymers, cellulose, and bio-molecules can all be glued by graphene glue on substrates. Graphene glue as binders can exhibit both the benefits of graphene and the glued materials, showing perfect accumulative effects. Compression can enhance the adhesion, electronic and thermal conductivity of graphene glue.

### FIELD OF THE INVENTION

The present invention relates to a method of using graphene glue which glues a variety of materials, such as metal powders, carbon powders, oxides, polymers, cellulose, inorganic compounds and bio-molecules, etc.

### BACKGROUND OF THE INVENTION

Most binders primarily consist of polymers, resins, acrylic or starch, etc. Those ingredients are almost thermal and electric insulates. Graphene has been widely used as filler into binders. However, the percentage of graphene filler is still relatively low that confines the performance enhancement of graphene. Most of binders that insert graphene as fillers involve complicated production process

Binders play an important role in many applications. The most useful function is to adhesive different materials/components together. Binders are most composed of polymers(acrylic and epoxy), or animal/plant sources (gum), cement, or inorganic compound(silica and phosphates). Although they have good adhesion property, most of them are thermal and electric insulates, which limits the application in electronics products.

Graphene, successfully discovered by Andre Geim and Konstantin Novoselov, has outstanding properties such as high thermal and electric conductivity, high surface area, and the strongest material ever tested. Therefore, many attempts have been tried to incorporate graphene into binder system.

Graphene is used as fillers. For example, most graphene composite binders only use relatively small amount of graphene. The idea in these inventions was to use graphene as a filler, and binders are still the main component. For example, graphene in total solids only accounts for 1.5˜3.5% (CN 103540280), 0.5-1% (CN 102925100), 1˜30% (CN 104099050), 10%˜20% (CN 104004482.) Limited addition of graphene also confines its effect on binder improvement.

In 2013, graphene was disclosed in CN 102102001B to be incorporated into epoxy system, but it involves complex sequence steps, long processing time and vacuum environment. Such processes are not favorable to mass production.

Another way to exploit the property of graphene is to introduce a layer-to-layer structure, wherein graphene and binder are separated. Such design may have feasibility issues and cause troubles in practical application, since it's always easier to direct paste a glue when we use binder. And conduction improvements may also be questioned in such design, since original insulate binders still remains unchanged.

The present invention has arisen to mitigate and/or obviate the afore-described disadvantages.

### SUMMARY OF THE INVENTION

One aspect of the present invention is to provide a graphene glue in which graphene is directly used as adhesive that can bind two different parts together, including material-material, material-surface, or surface-surface binding.

Another aspect of the present invention is to provide a method of using graphene glue which glues a variety of materials, such as metal powders, carbon powders, oxides, polymers, cellulose, inorganic compounds and bio-molecules.

To obtain above-mentioned aspects, graphene glue provided by the present invention consists of graphene, dispersants, and carriers. The graphene includes one layer, few layers and multiple layers with thickness ranging from 1 nm to 200 nm and flake sizes range from 0.5 to 100 um accounts for 90 to 99.99 wt % of a total solid content.

The dispersants are non-ionic dispersant or ionic dispersant. At least one of the dispersants is added at 0.01 to 10 wt % of the total solid content.

The carriers are aqueous, organic, or inorganic species.

In addition, a method of using graphene glue provided by the present invention contains steps of:

A. mixing the to-be-glued materials with graphene glue;

B. coating the solution onto surface/substrates;

C. covering the other surface/substrate if there is any; and

D. drying the surface.

In step A, materials are mixed before, during or after the production of graphene glue to get well dispersion.

Preferably, the materials are any one of metal powders, carbon powders, metal oxides, polymers, cellulose, and bio-molecules.

Thereby, the adhesion of graphene glue can be enhanced by compression, which also improves its resistance and thermal conductivity.

The graphene glue as binders can exhibit both the benefits of graphene and the glued materials, showing perfect accumulative effects. Accordingly, graphene glue exhibits not only excellent adhesion, but also high thermal conductivity and electric conductivity.

### BRIEF DESCRIPTION OF THE DRAWINGS

FIG. 1 is SEM cross section image before compression according to a preferred embodiment of the present invention.

FIG. 2 is SEM cross section image after compression according to the preferred embodiment of the present invention.

FIGS. 3(a) to 3(c) show graphene glue being used to adhesive silver powders on paper according to the preferred embodiment of the present invention.

FIGS. 4(a) to 4(c) show graphene glue being used to adhesive natural graphite (NG) on paper according to the preferred embodiment of the present invention.

FIGS. 5(a) and 5(b) show graphene glue coating without compression had severe peeling at the edges, while after compression the coating was completely intact.

FIG. 6 is a table showing compression effect on the resistance can be observed according to the preferred embodiment of the present invention.

FIG. 7 shows compressed graphene laminate has higher thermal conductivity according to the preferred embodiment of the present invention.

FIGS. 8(a) to 8(d) are a diagram showing the application of a method of using graphene glue according to a preferred embodiment of the present invention.

FIG. 9 is a diagram showing graphene glue had cooling effect when PMMA was bound, and perfect accumulative effect on cooling enhancement according to the preferred embodiment of the present invention.

### DETAILED DESCRIPTION OF THE PREFERRED EMBODIMENTS

Graphene has sp2-bonded carbon atoms, making it super favorable for electron and phonon transfer. It is also robust and can sustain high strain, but flexible at the same time. These properties makes graphene a suitable medium to bridge, wrap, or cage other particles, while remaining both structure and property of graphene and other material intact.

The adhesion of graphene comes from Van Der Waals force between layers. It is well known that smaller distance between layers can enlarge the force. Due to this adhesion property, graphene can easily form free standing films by simply air suctioning the well dispersed graphene inks. This film-forming ability from layer-to-layer adhesion enables graphene to become binder that adhesive particle.

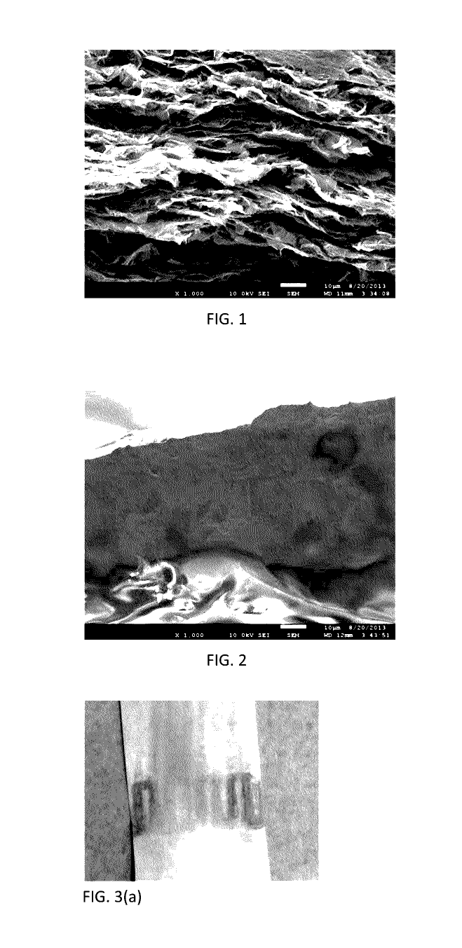

Compression can improve graphene glue's adhesion, and electric as well as thermal conductivity. For adhesion, it is quite straight forward that compression can enormously decrease the distance between substances, and the Van Der Waal forces increase. For conductivity enhancement, compression helps to align the graphene flakes from random stacking (as shown in FIG. 1) to ordered arrangements (as shown in FIG. 2). The enhancement from compression is very effective, because graphene and few-layer graphene are naturally curved and folded. Compression then not only decreases layer resistance, but also expels the air, and forge continuous channels and bridges for better conductance. Effective compression ratio ranges from 0.5 to 99% of thickness changes.

According to the aforementioned physics of graphene glue, it's adhesives comes from Van Der Waal forces between layers. Therefore, to-be-glue materials need to be mixed well with graphene glue first to ensure materials are well dispersed between graphene layers. After drying graphene glue, graphene then can form cages, bridges, or nets that trap the materials, while still forging a continuous channel for electronic and heat conductance.

One advantage of graphene glue that differentiates from other binders is its accumulative effect when binding other materials. Due to the Van Der Waals forces, the structure of both graphene and glued materials is almost not affected, when they are bound together. Therefore, both the properties of glued materials and graphene can still remain. That is, graphene glue's performance can be further improved by the glued materials.

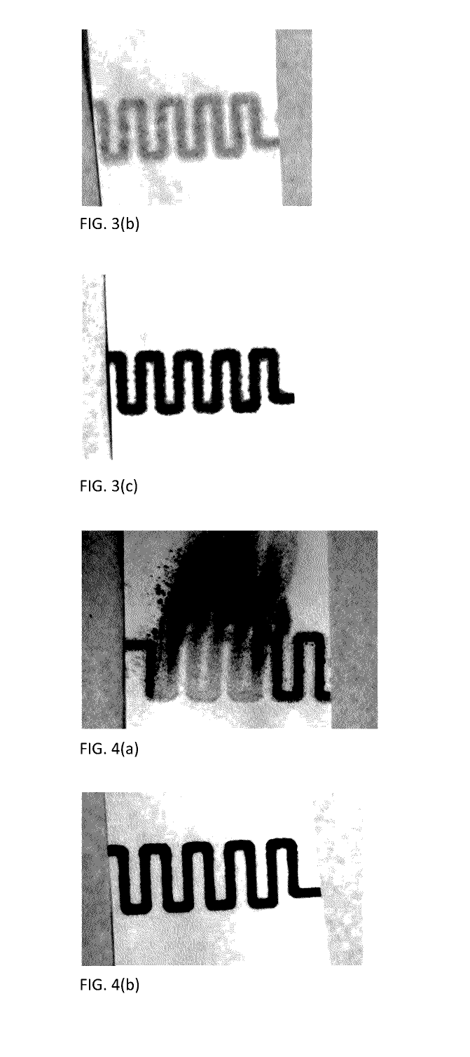

For example, graphene glue was used to adhesive silver powders and natural graphite (NG) on paper. For comparison, powders only (as illustrated in FIGS. 3(a) and 4(a)), with commercial binder (as illustrated in FIGS. 3(b) and 4(b)), with graphene glue (as illustrated in FIGS. 3(c) and 4(c)) are printed with the same pattern on papers.

After wiping by hand, one can find that powders with graphene glue have excellent adhesion comparable to commercial binder. On the contrary, conductive line of pure silver or natural graphite powders were almost wiped out.

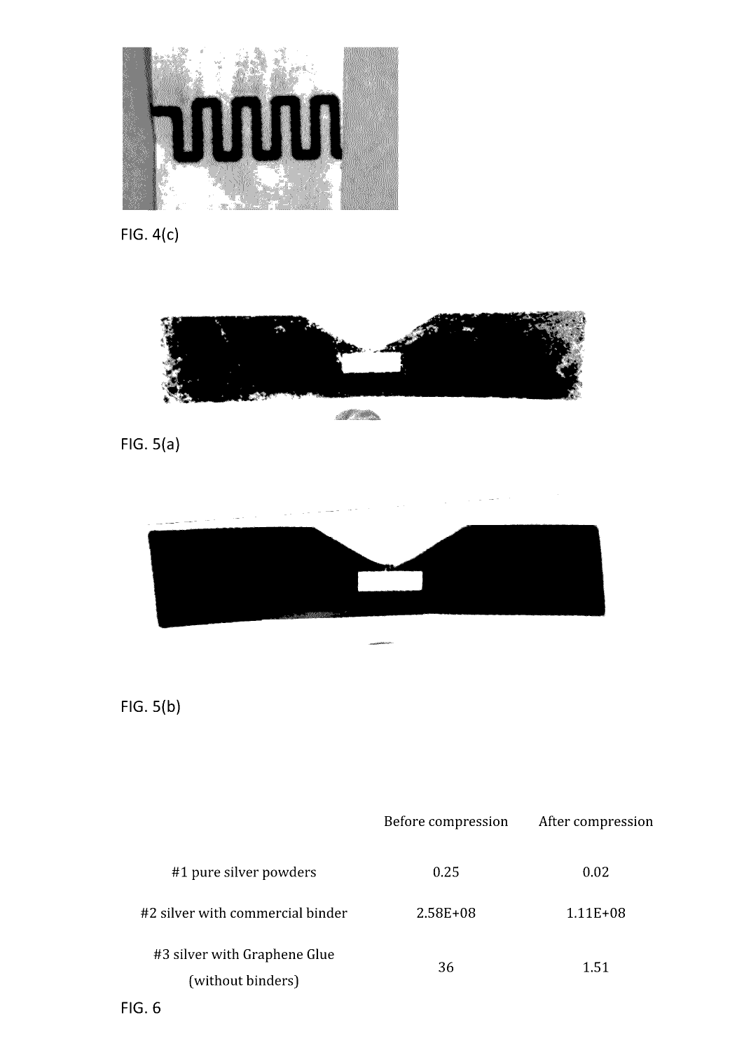

In this test, graphene glue was used to adhesive silver powders onto paper. To illustrate the adhesion improvement by compression, the patterns were bended for 100 times to see if any peeling-offs can be found. As shown in FIGS. 5(a) and 5(b), graphene glue coating without compression had severe peeling at the edges, while after compression the coating was completely intact.

For comparison at the same base, powders/binder ratio is fixed at 2.5 for all the samples to see the resistance difference.

For pure silver powders, the content of silver was 3 times higher than the other samples to have acceptable coating, due to silver's poor film-forming ability. So the resistance was also much lower.

Silver with commercial binder showed extremely high resistance, because binders were insulated and the conductive silver was too little to forge conductive channels within binders.

Silver with graphene glue then exhibited good conductivity.

Compression effect on the resistance can be observed in the table (as shown in FIG. 6). Compression can enormously reduce the resistance up to one order smaller for both pure silver and silver with graphene glue. However, the difference was relatively small for commercial binders.

Note that with only 15 wt % of silver in the total ink composition, the resistance of ink can reach as low as 1.5 ohm/sq/mil. This illustrates strong evidence that graphene glue in this invention had great competitiveness to commercial binders.

Thermal conductivity improvements of graphene glue (without binders) by compression has also been illustrated and discussed in our previous published paper (Nano Lett. 2014, 14, 5155-5161.)

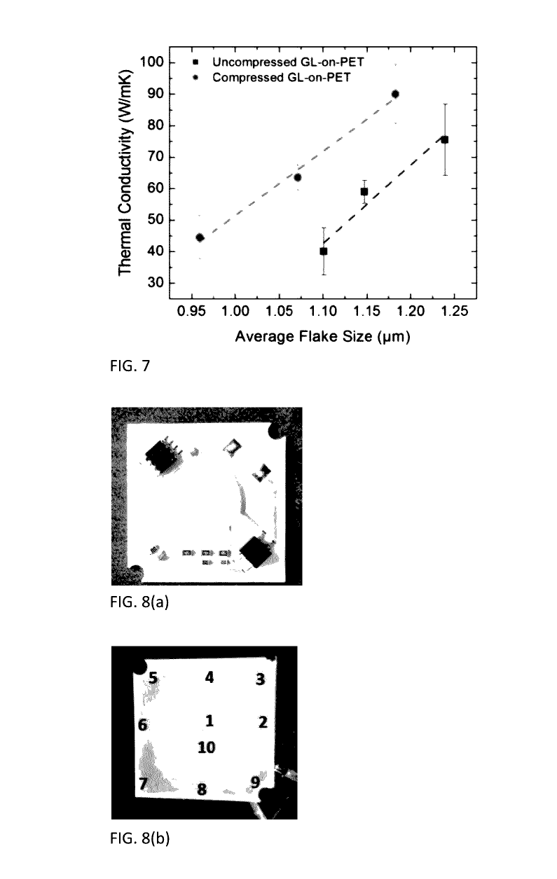

With reference to FIG. 7, it can find that for the same flake size, compressed graphene laminate has higher thermal conductivity.

In this test, the accumulative effects of graphene glue mixed with other polymers are illustrated.

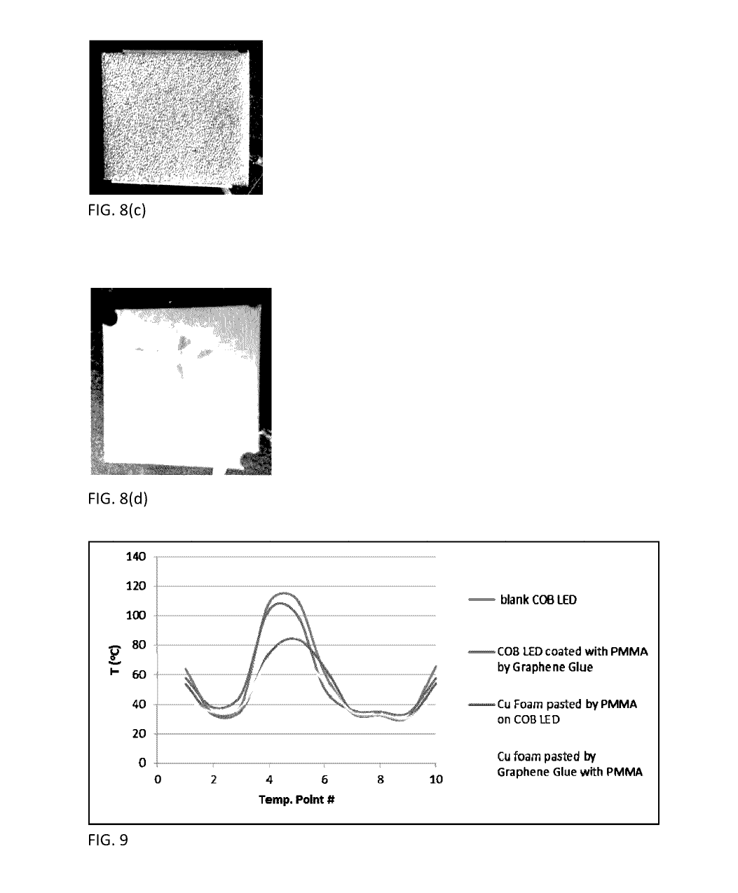

One polymer, polymethylmethacrylate (PMMA), has been widely used as adhesive raw materials. It was used as the glued material in this illustration. As shown in FIGS. 8(a) to 8(d), we pasted copper foam onto a back side of a Chip On Board LED (COB LED) by pure PMMA. Graphene glue was used to glue PMMA between copper foam and COB LED. Plus, PMMA was glued by graphene glue on the back side of COB LED without copper foam.

For the temperature measurement, we measured the temperature on the same location of the surface, after the COB LED was lightened up for 10 minutes. Total 10 locations were measured as shown in FIG. 8(b). With reference to FIG. 9, graphene glue had cooling effect when PMMA was bound, so did copper foam when glued by pure PMMA.

When graphene glue binds PMMA between copper foam and COB LED, the temperature was lower, which shows perfect accumulative effect on cooling enhancement.

The accumulative effect of graphene glue not only has advantage from graphene but also from the glued materials. Preferably, we show graphene glue can retain the benefits of glued-material such as water-resistance, anti-corrosion, and low temperature resistant.

Graphene glue was used to glue several materials on copper foil. Later the coating was soaked in slat water, frozen in the refrigerator and ripped by strong tapes.

Graphene glue according to a preferred embodiment of the present invention consists of graphene, dispersants, and carriers. The graphene includes one layer, few layers and multiple layers with thickness ranging from 1 nm to 200 nm and flake sizes range from 0.5 to 100 um accounts for 90 to 99.99 wt % of a total solid content.

The dispersants are non-ionic dispersant or ionic dispersant. At least one of the dispersants is added at 0.01 to 10 wt % of the total solid content.

The carriers are aqueous, organic, or inorganic species.

Thereby, the adhesion of graphene glue can be enhanced by compression, which also improves its resistance and thermal conductivity.

The graphene glue as binders can exhibit both the benefits of graphene and the glued materials, showing perfect accumulative effects. Accordingly, graphene glue exhibits not only excellent adhesion, but also high thermal conductivity and electric conductivity.

In addition, a method of using graphene glue according to a preferred embodiment of the present invention comprises steps of:

A. mixing the to-be-glued materials with graphene glue;

B. coating the solution onto surface/substrates;

C. covering the other surface/substrate if there is any; and

D. drying the surface.

In step A, materials could be mixed before, during or after the production of graphene glue to get well dispersion.

Preferably, the materials are any one of metal powders, carbon powders, metal oxides, polymers, cellulose, and bio-molecules.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. Graphene glue consisting of graphene, dispersants, and carriers, where in the graphene includes one layer, few layers and multiple layers with thickness ranging from 1 nm to 200 nm and flake sizes range from 0.5 to 100 um accounts for 90 to 99.99 wt % of a total solid content.

2. The graphene glue as claimed in claim 1, where in the dispersant is non-ionic dispersant or ionic dispersant.

3. The graphene glue as claimed in claim 1, where in at least one of the dispersants is added at 0.01 to 10 wt % of the total solid content.

4. The graphene glue as claimed in claim 1, where in the carriers are aqueous, organic, or inorganic species.

5. A method of using graphene glue comprising steps of:
A. mixing the to-be-glued materials with graphene glue;
B. coating a solution onto surface/substrates;
C. covering the other surface/substrate if there is any; and
D. drying the surface.

6. The method of using graphene glue as claimed in claim 5, where in step A, materials are mixed before, during or after a production of the graphene glue.

7. The method of using graphene glue as claimed in claim 5, where in the materials are any one of metal powders, carbon powders, metal oxides, polymers, cellulose, and bio-molecules.

8. The method of using graphene glue as claimed in claim 5, compression can enhance the adhesion, electronic and thermal conductivity of graphene glue if there is a demand.
